(19) United States
(12) Patent Application Publication
(10) Pub. No.: US 2024/0152459 A1
(43) Pub. Date: May 9, 2024

(54) METHOD FOR MANAGING MEMORY WRITE REQUEST IN CACHE DEVICE

(71) Applicant: RDC Semiconductor Co., Ltd., Hsinchu City (TW)

(72) Inventor: Yao-An TSAI, Hsinchu City (TW)

(21) Appl. No.: 18/113,307

(22) Filed: Feb. 23, 2023

(30) Foreign Application Priority Data
Nov. 9, 2022 (TW) 111142793

(51) Int. Cl. G06F 12/0831; G06F 12/0897; G06F 13/16

(52) U.S. Cl. CPC G06F 12/0833; G06F 12/0897; G06F 13/1673

(57) ABSTRACT

A method for managing a memory write request in a cache device is provided. The cache device is coupled between a central processing unit and a system memory. The cache memory includes plural levels. An Nth level of the cache device includes an Nth-level command buffer, an Nth-level cache memory and a write allocation buffer, wherein N is an integer larger than 1. The method includes the following steps. Firstly, a request is received from a previous level. If the request is the memory write request, the memory write request is temporarily stored into a free entry of the write allocation buffer. The memory write request contains an address information and a write data. If the request is not the memory write request, the request is temporarily stored into a free entry of the Nth-level command buffer.

This application claims the benefit of Taiwan Patent Application No. 111142793, filed Nov. 9, 2022, the subject matter of which is incorporated herein by reference.

### FIELD OF THE INVENTION

The present invention relates to a managing method for a cache device in a computer system, and more particularly to a method for managing a memory write request in a cache device of a computer system.

### BACKGROUND OF THE INVENTION

In a computer system, the operating speed of the central processing unit (CPU) and the operating speed of the system memory are very distinguished. When the central processing unit accesses the system memory, it is usually time-consuming to wait for the system memory to perform the access action. For solving this problem, the computer system is provided with a cache device, and the cache device is connected between the central processing unit and the system memory. The accessing speed of the cache device is faster than the accessing speed of the system memory. Of course, the cache device may be directly integrated into the central processing unit.

FIG. 1 is a schematic functional block diagram illustrating the architecture of a cache device in a conventional computer system. As shown in FIG. 1, the cache device 170 is coupled to a central processing unit (CPU) 150. In addition, the cache device 170 is coupled to a system memory 160 through a bus. The central processing unit 150 can continuously issue plural requests to access the system memory 160. If a request is a memory write request, the request contains an address information and a write data. If a request is a memory read request, the request contains an address information.

The cache device 170 comprises plural cache memories 112, 122 and 132. Each of the plural cache memories 112, 122 and 132 comprises plural cache lines. For example, the second-level cache memory 122 comprises M cache lines, wherein M is an integer larger than 1. Each cache line can at least record an address information and a storage data. Of course, the number of cache lines in the cache memories 112, 122 and 132 may be identical or different.

When the central processing unit 150 issues a request to the system memory 160, the following process will be performed. Firstly, the cache device 170 receives the request. Then, the cache device 170 judges whether any of all cache lines of the cache memories 112, 122 and 132 records the same address information as the request. If the address information recorded in one cache line of the cache memories 112, 122 and 132 is identical to the address information in the request, a cache hit occurs. Whereas, if all pieces of address information recorded in all cache lines of the cache memories 112, 122 and 132 are different from the address information in the request, a cache miss occurs. Hereinafter, some situations will be described.

If the cache hit occurs and the request is a memory read request, the stored data in the corresponding cache line of the cache memories 112, 122 and 132 is used as a read data by the cache device 170, and the read data is transmitted back to the central processing unit 150.

If the cache hit occurs and the request is a memory write request, a write data is updated in the corresponding cache line of the cache memories 112, 122 and 132 by the cache device 170. That is, the stored data in the corresponding cache line is updated.

If the cache miss occurs and the request is a memory read request, the request is transmitted to the system memory 160 by the cache device 170. According to the request, the read data is transmitted from the system memory 160 to the central processing unit 150 and the cache device 170. After the read data is received by the cache device 170, the cache device 170 will search an available cache line (e.g., an empty cache line) from the cache memories 112, 122 and 132 to store the address information and the read data.

Moreover, if the cache miss occurs and the request is a memory write request, the request is transmitted to the system memory 160 by the cache device 170, and a write data is updated in the system memory 160. The operations of the cache device 170 will be described in more details as follows.

As shown in FIG. 1, the cache device 170 is divided into plural levels, e.g., N levels. For example, the cache device 170 comprises a first-level (L₁) cache memory 112, a second-level (L₂) command buffer 120, a second-level cache memory 122, an Nth-level (L_{N}) command buffer 130 and an Nth-level cache memory 132, wherein N is an integer higher than 1. The Nth-level command buffer 130 and the Nth-level cache memory 132 are respectively the last level command buffer and the last level cache memory of the cache device 170.

When the central processing unit 150 issues a request to the cache memory 170, the cache memory 170 judges whether the first-level cache memory 112 is hit.

If the cache hit occurs and the request is a memory read request, the stored data in the corresponding cache line of the first-level cache memory 112 is the read data, and the read data is transmitted back to the central processing unit 150. In addition, the memory read request is retired, indicating that the memory read request has been completed.

If the cache hit occurs and the request is a memory write request, a write data is updated in the corresponding cache line of the first-level cache memory 112. That is, the stored data in the corresponding cache line is updated. Then, the memory write request is retired, indicating that the memory write request has been completed.

If the cache miss occurs, the request is transmitted to the second-level command buffer 120. The second-level command buffer 120 contains plural entries for temporarily storing plural requests. Each entry can temporarily store one request. That is, when the request is transmitted to the second-level command buffer 120, the request is temporarily stored in a free entry of the second-level command buffer 120. Generally, the entry where a request has been stored is regarded as a used entry, and the entry where no request has been stored is regarded as a free entry. Moreover, the second-level command buffer 120 and the second-level cache memory 122 cooperate with each other.

The cache memory 170 may select one request from the plural used entries in the second-level command buffer 120 and judge whether the second-level cache memory 122 is hit.

For example, the cache device 170 selects one request from the second-level command buffer 120 and judges whether the second-level cache memory 122 is hit. If the second-level cache memory 122 is hit and the request is a memory read request, the stored data in the corresponding cache line of the second-level cache memory 122 is the read data. The read data is transmitted back to the central processing unit 150. In addition, the memory read request is retired, indicating that the memory read request has been completed.

If the second-level cache memory 122 is hit and the request is a memory write request, the write data is updated in the corresponding cache line of the second-level cache memory 122. That is, the stored data in the corresponding cache line is updated. Then, the memory write request is retired, indicating that the memory write request has been completed.

Generally, after the request is retired, the content in the corresponding used entry is cleared or set as an invalid data, and the used entry is changed into a free entry for temporarily storing a new request in the future.

If the cache miss occurs, the request will be transmitted to the next-level command buffer. Similarly, the next-level command buffer contains plural entries for temporarily storing plural requests. Each entry can temporarily store one request. That is, when the request is transmitted to the next-level command buffer, the request is temporarily stored in a free entry of the next-level command buffer. Moreover, the next-level command buffer and the next-level cache memory cooperate with each other. The operations of the next-level command buffer and the next-level cache memory are similar to the operations of the second-level command buffer 120 and the second-level cache memory 122, and not redundantly described herein.

If the cache miss continuously occurs, the request will be finally sent to the Nth-level command buffer 130. The Nth-level command buffer 130 contains plural entries for temporarily storing plural requests. Each entry can temporarily store one request. That is, when the request is transmitted to the Nth-level command buffer 130, the request is temporarily stored in a free entry of the Nth-level command buffer 130. Moreover, the Nth-level command buffer 130 and the Nth-level cache memory 132 cooperate with each other.

Similarly, the cache memory 170 may select one request from the plural used entries of the Nth-level command buffer 130 and judge whether the Nth-level cache memory 132 is hit.

For example, the cache device 170 selects one request from the Nth-level command buffer 130 and judges whether the Nth-level cache memory 132 is hit. If the Nth-level cache memory 132 is hit and the request is a memory read request, the stored data in the corresponding cache line of the Nth-level cache memory 132 is the read data. The read data is transmitted back to the central processing unit 150. In addition, the memory read request is retired, indicating that the memory read request has been completed.

If the Nth-level cache memory 132 is hit and the request is a memory write request, the write data is updated in the corresponding cache line of the Nth-level cache memory 132. That is, the stored data in the corresponding cache line is updated. Then, the memory write request is retired, indicating that the memory write request has been completed.

If the cache miss occurs, the request will be transmitted to the system memory 160. For example, the request is a memory read request. After the memory read request is transmitted from the cache device 170 to the system memory 160, the system memory 160 generates a read data according to the memory read request. In addition, the read data is transmitted from the system memory 160 to the central processing unit 150 and the cache device 170. Meanwhile, the address information in the memory read request and the read data are combined by the cache device 170. In addition, the cache device 170 will search at least one available cache line from the cache memories 112, 122 and 132 to store the address information and the read data. Then, the memory read request is retired, indicating that the memory read request has been completed.

Alternatively, the request is a memory write request. After the memory write request is transmitted from the cache device 170 to the system memory 160, the memory write request is retired, indicating that the memory write request has been completed. Moreover, according to the address information of the memory write request, the write data is updated in the system memory 160.

As known, during the operation of the computer system, the central processing unit 150 continuously issues requests. In other words, all command buffers 120 and 130 in the cache device 170 continuously receive requests, temporarily store requests, execute requests, retire requests or transmit requests to the next levels.

### SUMMARY OF THE INVENTION

An embodiment of the present invention provides a method for managing a memory write request in a cache device. The cache device is coupled between a central processing unit and a system memory. The cache memory includes plural levels. An Nth level of the cache device includes an Nth-level command buffer, an Nth-level cache memory and a write allocation buffer, wherein N is an integer larger than 1. The method includes the following steps. Firstly, a request is received from a previous level. If the request is the memory write request, the memory write request is temporarily stored into a free entry of the write allocation buffer. The memory write request contains an address information and a write data. If the request is not the memory write request, the request is temporarily stored into a free entry of the Nth-level command buffer.

Another embodiment of the present invention provides a method for managing a memory write request in a cache device. The cache device is coupled between a central processing unit and a system memory. The cache memory includes plural levels. An Nth level of the cache device includes an Nth-level command buffer, an Nth-level cache memory and a write allocation buffer, wherein N is an integer larger than 1. The method includes the following steps. Firstly, a request is received from a previous level. If the request is not the memory write request, the request is temporarily stored into a free entry of the Nth-level command buffer. If the request is the memory write request, the memory write request is transmitted to the write allocation buffer. The memory write request contains an address information and a write data. If all used entries in the write allocation buffer do not record a same address information as the address information in the memory write request, the memory write request is temporarily stored into a free entry of the write allocation buffer. If only a specified used entry in the write allocation buffer records the same address information as the address information in the memory write request and the write data is mergeable, the write data in the memory write request is merged into a stored data in the specified used entry, and the memory write request is retired. If only the specified used entry in the write allocation buffer records the same address information as the address information in the memory write request and the write data is not mergeable, the memory write request is temporarily stored into the free entry of the write allocation buffer. If at least two used entries in the write allocation buffer record the same address information as the address information in the memory write request, the write data in the memory write request is merged into a stored data in a newest used entry, and the memory write request is retired.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating the architecture of a cache device of a conventional computer system;

FIG. 2 is a flowchart illustrating a method for managing a memory write request in a cache device of a computer system according to a first embodiment of the present invention;

FIG. 3A is a schematic functional block diagram illustrating the architecture of a cache device of a computer system according to an embodiment of the present invention;

FIG. 3B is a flowchart illustrating a method for managing a memory write request by using a write allocation buffer according to a second embodiment of the present invention;

FIG. 3C is a flowchart illustrating a method for executing the memory write request in the cache device according to the second embodiment of the present invention;

FIG. 4 is a flowchart illustrating a variant example of the method for managing the memory write request by using the write allocation buffer according to the second embodiment of the present invention; and

FIGS. 5A to 5F schematically illustrate some scenarios of the managing procedures in the write allocation buffer.

### DETAILED DESCRIPTION OF PREFERRED EMBODIMENTS

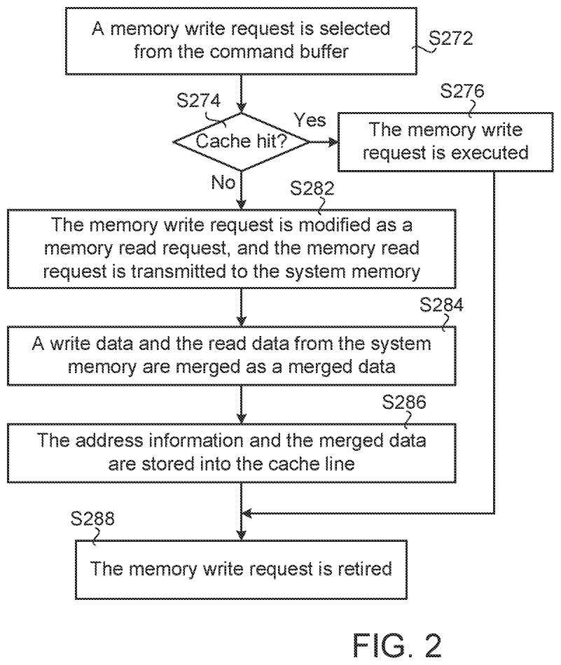

FIG. 2 is a flowchart illustrating a method for managing a memory write request in a cache device of a computer system according to a first embodiment of the present invention. The managing method can be applied to the cache device 170 of the computer system as shown in FIG. 2. Hereinafter, the Nth-level command buffer 130 and the Nth-level cache memory 132 will be taken as examples for illustration. Of course, the management method of the present invention can be applied to other command buffers and other cache memories.

Firstly, the cache device 170 selects a memory write request from the Nth-level command buffer 130 (Step S272). Then, the cache device 170 judges whether the Nth-level cache memory 132 is hit (Step S274). That is, the cache device 170 judges whether any of all cache lines of the Nth-level cache memory 132 records the same address information as the memory write request. If the address information recorded in one cache line of the Nth-level cache memory 132 is identical to the address information in the memory write request, a cache hit occurs. Whereas, if all pieces of address information recorded in all cache lines of the Nth-level cache memory 132 are different from the address information in the memory write request, a cache miss occurs.

If the judging result of the step S274 indicates that the cache hit occurs, the cache device 170 executes the memory write request (Step S276). That is, the write data is updated in the corresponding cache line of the Nth-level cache memory 132 by the cache device 170. In addition, the stored data in the corresponding cache line is updated. Then, the memory write request is retired (step S288), indicating that the memory write request has been completed.

If the judging result of the step S274 indicates that the cache miss occurs, the memory write request is modified as a memory read request by the cache device 170 and the memory read request is transmitted from the cache device 170 to the system memory 160 (Step S282).

For example, in case that the cache miss occurs in the Nth-level cache memory 132, the memory write request is modified as a memory read request by the cache device 170 and the memory read request is transmitted from the cache device 170 to the system memory 160. Then, the system memory 160 generates a read data according to the memory read request, and the read data is transmitted back to the cache device 170. Since the memory read request corresponding to the read data is not issued by the central processing unit 150, the read data will not be transmitted back to the processing unit 150. In other words, the read data is transmitted to the cache device 170 only. After the read data from the system memory 160 is received by the cache device 170, a write data in the memory write request is merged into the read data by the cache device 170 (Step S284). That is, the write date and the read data are merged as a merged data. Then, the address information and the merged data are stored into the cache line (step S286). Afterwards, the memory write request is retired (step S288).

As mentioned above, after the read data from the system memory 160 is received, the write data in the memory write request in the Nth-level command buffer 130 and the read data are merged as the merged data by the cache device 170. Then, the address information in the memory write request and the merged data are stored into a cache line of the Nth-level cache memory 132. After the memory write request in the Nth-level command buffer 130 is retired, the memory read request has been completed.

Obviously, when the central processing unit 150 continuously issues plural memory write requests with the same address information, the cache device 170 can be operated more efficiently by using the managing method of the first embodiment. For example, in case that the central processing unit 150 continuously issues five memory write requests with the same address information, the following process will be performed.

The first memory write request will be subjected to the management procedures of the steps S272, S274, S282, S284, S286 and S288. That is, the first memory write request is modified as a memory read request, and the memory read request is transmitted to the system memory 160. After the read data is transmitted from system memory 160 is to the cache device 170, the read data and the write data are merged as a merged data by the cache device 170. Then, the address information and the merged data are stored into a cache line of the Nth-level cache memory 132, and the first memory write request is retired.

Then, the second memory write request, the third memory write request, the fourth memory write request and the fifth memory write request are sequentially subjected to the management procedures of the steps S272, S274, S276 and S288 only. In other words, the Nth-level cache memory 132 of the cache device 170 is hit when the second memory write request, the third memory write request, the fourth memory write request and the fifth memory write request are received. Since the second memory write request, the third memory write request, the fourth memory write request and the fifth memory write request are not transmitted to the system memory 160, the performance of the cache device 170 is enhanced.

However, the managing method of first embodiment still has some drawbacks. For example, after the memory read request is transmitted from the cache device 170 to the system memory 160, it will take a long time for the system memory 160 to generate the read data and transmit the read data to the cache device 170. That is, in the steps S282, S283 and S284 of FIG. 2, the waiting time is relatively long. Consequently, the performance of the cache device 170 is deteriorated.

In an embodiment, the Nth-level command buffer 130 is an in-order command buffer. Since the cache device 170 is waiting for the read data that will be transmitted back from the system memory 160, it means that the memory write request in the Nth-level command buffer 130 has not been retired. Meanwhile, the cache device 170 cannot select the other requests from the Nth-level command buffer 130 for execution. That is, until the memory write request has been retired, the other requests can be executed.

Alternatively, in another embodiment, the Nth-level command buffer 130 is an out-of-order command buffer. Since the cache device 170 is waiting for the read data that will be transmitted back from the system memory 160, it means that the memory write request in the Nth-level command buffer 130 has not been retired. Meanwhile, the cache device 170 can executes the other requests in the Nth-level command buffer 130. However, the waiting time is still longer. After the other requests in the Nth-level command buffer 130 are completed, the memory write request becomes the oldest request in the Nth-level command buffer 130, and this oldest request has not retired. Meanwhile, the Nth-level command buffer 130 cannot receive the new requests. Until the oldest memory write request is retired, the Nth-level command buffer 130 can continuously receive other requests.

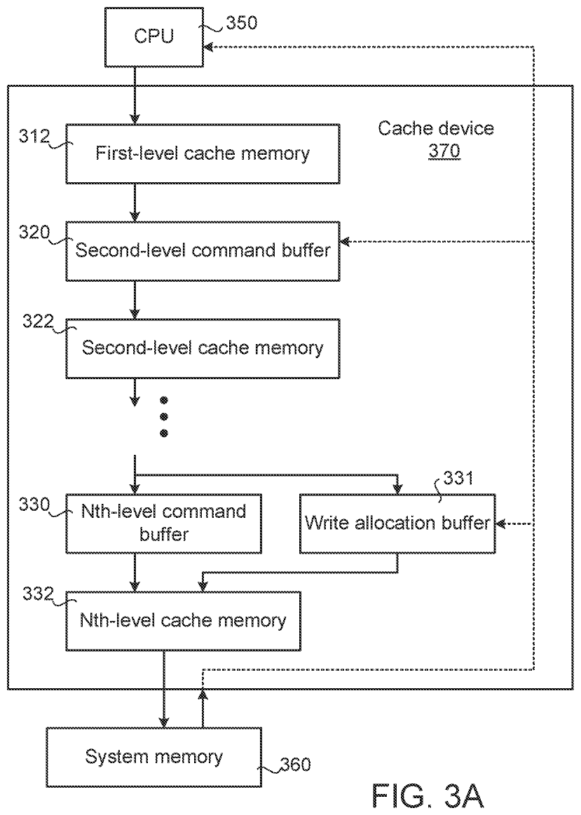

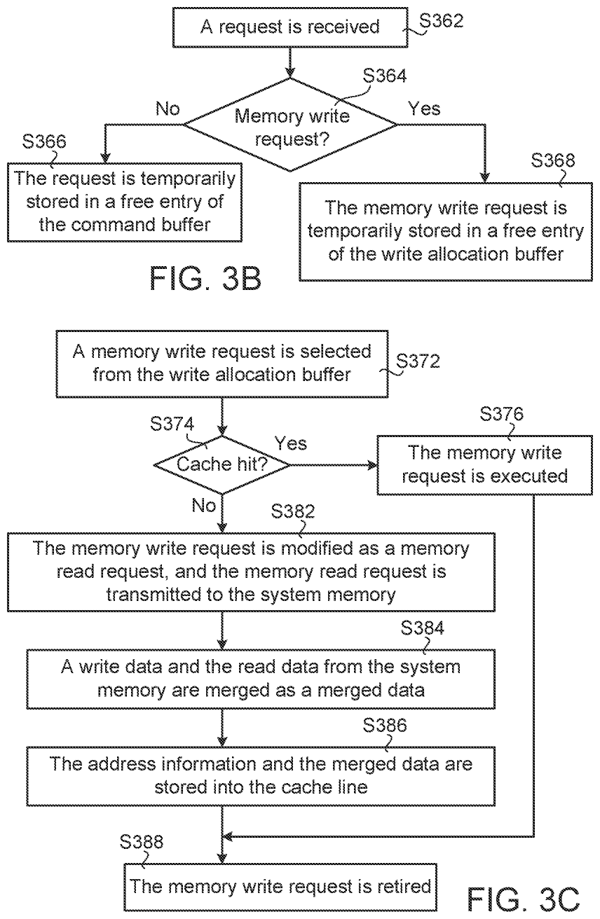

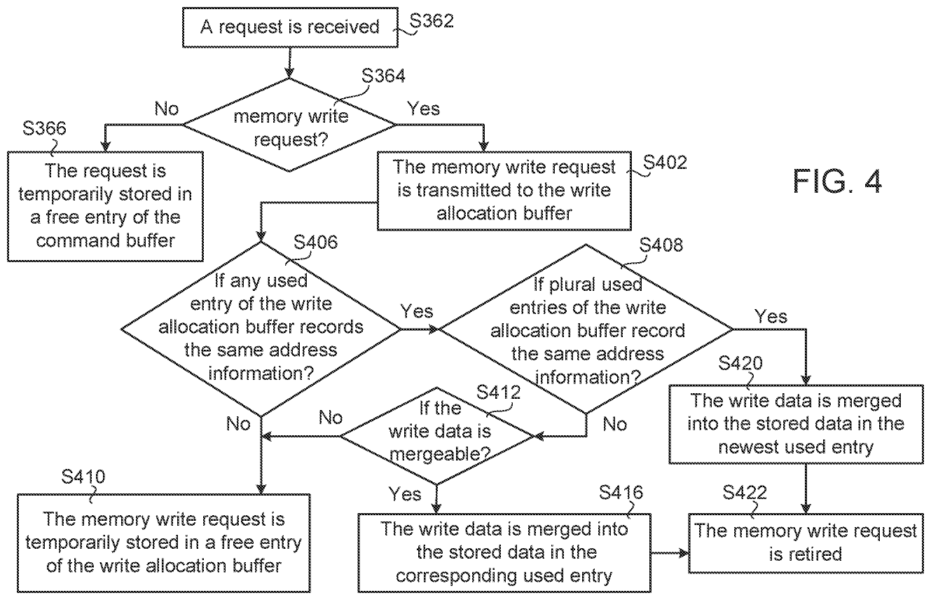

For overcoming the drawbacks of the managing method of the first embodiment, the cache device and managing method of the first embodiment need to be modified. FIG. 3A is a schematic functional block diagram illustrating the architecture of a cache device of a computer system according to an embodiment of the present invention. FIG. 3B is a flowchart illustrating a method for managing a memory write request by using a write allocation buffer according to a second embodiment of the present invention. FIG. 3C is a flowchart illustrating a method for executing the memory write request in the cache device according to the second embodiment of the present invention.

As shown in FIG. 3A, the cache device 370 is coupled to a central processing unit (CPU) 350. In addition, the cache device 370 is coupled to a system memory 360 through a bus. The central processing unit 350 can continuously issue plural requests to access system memory 360. If a request is a memory write request, the request contains an address information and a write data. If a request is a memory read request, the request contains an address information.

The cache device 370 comprises plural cache memories 312, 322 and 332. Each of the plural cache memories 332, 322 and 332 comprises plural cache lines. For example, the second-level cache memory 322 comprises M cache lines, wherein M is an integer larger than 1. Each cache line can at least record an address information and a storage data. Of course, the number of cache lines in the cache memories 312, 322 and 332 may be identical or different.

As shown in FIG. 3A, the cache device 370 is divided into plural levels, e.g., N levels. For example, the cache device 370 comprises a first-level (L₁) cache memory 312, a second-level (L₂) cache memory 320, a second-level cache memory 322, an Nth-level (L_{N}) command buffer 330, a write allocation buffer 331 and an Nth-level cache memory 332, wherein N is an integer higher than 1. The Nth-level command buffer 330 and the Nth-level cache memory 332 are respectively the last level command buffer and the last level cache memory of the cache device 370.

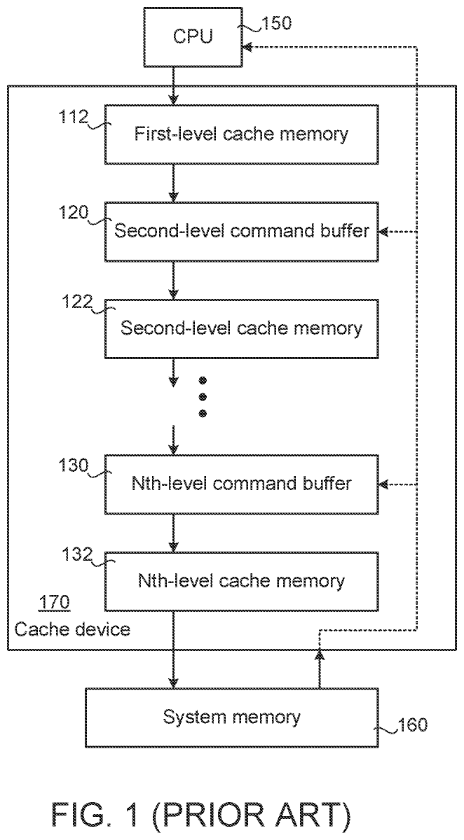

In comparison with the cache device 170 of FIG. 1, the cache device 370 of this embodiment further comprises the write allocation buffer 331. The write allocation buffer 331 is connected between the Nth-level command buffer 330 and the Nth-level cache memory 332. The write allocation buffer 331 is used for temporarily storing the memory write requests. The operations of the cache device 370 will be described in more details as follows.

When the central processing unit 350 issues a request to the cache memory 370, the cache memory 370 judges whether the first-level cache memory 312 is hit.

If the cache hit occurs and the request is a memory read request, a stored data of the corresponding cache line of the first-level cache memory 312 is the read data, and the read data is transmitted back to the central processing unit 350. In addition, the memory read request is retired, indicating that the memory read request has been completed.

If the cache hit occurs and the request is a memory write request, a write data is updated in the corresponding cache line of the first-level cache memory 312. That is, the stored data in the corresponding cache line is updated. Then, the memory write request is retired, indicating that the memory write request has been completed.

If the cache miss occurs, the request is transmitted to the second-level command buffer 320. The second-level command buffer 320 contains plural entries for temporarily storing plural requests. Each entry can temporarily store one request. That is, when the request is transmitted to the second-level command buffer 320, the request is temporarily stored in a free entry of the second-level command buffer 320. Generally, the entry where a request has been stored is regarded as a used entry, and the entry where no request has been stored is regarded as a free entry. Moreover, the second-level command buffer 320 and the second-level cache memory 322 cooperate with each other.

The cache memory 370 may select one request from the plural used entries in the second-level command buffer 320 and judge whether the second-level cache memory 322 is hit.

For example, the cache device 370 selects one request from the second-level command buffer 320 and judges whether the second-level cache memory 322 is hit. If the second-level cache memory 322 is hit and the request is a memory read request, the stored data in the corresponding cache line of the second-level cache memory 322 is the read data. The read data is transmitted back to the central processing unit 350. In addition, the memory read request is retired, indicating that the memory read request has been completed.

If the second-level cache memory 322 is hit and the request is a memory write request, the write data is updated in the corresponding cache line of the second-level cache memory 322. That is, the stored data in the corresponding cache line is updated. Then, the memory write request is retired, indicating that the memory write request has been completed.

If the cache miss occurs, the request will be transmitted to the next-level command buffer. Similarly, the next-level command buffer contains plural entries for temporarily storing plural requests. Each entry can temporarily store one request. That is, when the request is transmitted to the next-level command buffer, the request is temporarily stored in a free entry of the next-level command buffer. Moreover, the next-level command buffer and the next-level cache memory cooperate with each other. The operations of the next-level command buffer and the next-level cache memory are similar to the operations of the second-level command buffer 320 and the second-level cache memory 322, and not redundantly described herein.

If the cache miss continuously occurs, the request will be finally sent to the Nth-level command buffer 330 or the write allocation buffer 331. Each of the Nth-level command buffer 330 and the write allocation buffer 331 contains plural entries for temporarily storing plural requests. The entries of the write allocation buffer 331 are used for temporarily storing memory write requests. The Nth-level command buffer 330 are used for temporarily storing other requests.

Please refer to the flowchart of FIG. 3B. A method for managing the memory write request by using the write allocation buffer will be described as follows. Firstly, a request is received by the Nth level of the cache device (Step S362). Then, the cache device 370 judges whether the request is a memory write request (Step S364). If the request is the memory write request, the memory write request is temporarily stored in a free entry of the write allocation buffer 331 (Step S368). Whereas, if the request is another request, the request is temporarily stored in a free entry of the Nth-level command buffer (Step S366).

Moreover, the cache device 370 selects one request from plural used entries of Nth-level command buffer 330 or the write allocation buffer 331 and judges whether the Nth-level cache memory 332 is hit. That is, the Nth-level command buffer 330 and the write allocation buffer 331 are operated independently.

For example, the cache device 370 selects one request from the Nth-level command buffer 330, and the cache device 370 judges that the Nth-level cache memory 332 is hit. If the Nth-level cache memory 332 is hit and the request is a memory read request, the stored data in the corresponding cache line of the Nth-level cache memory 332 is the read data. Then, the read data is transmitted back to the central processing unit 350. In addition, the memory read request is retired, indicating that the memory read request has been completed. The method of managing the memory read request by the cache device 370 is similar to the conventional managing method and the managing method of the first embodiment. Consequently, only the method of managing the memory write request by the cache device 370 will be described as follows.

Please refer to the flowchart of FIG. 3C. When the cache device 370 selects a memory write request from the write allocation buffer 331 (Step S272), the cache device 370 judges whether the Nth-level cache memory 332 is hit (Step S374). That is, the cache device 370 judges whether any of all cache lines of the Nth-level cache memory 332 records the same address information as the memory write request. If the address information recorded in one cache line of the Nth-level cache memory 332 is identical to the address information in the memory write request, a cache hit occurs. Whereas, if all pieces of address information recorded in all cache lines of the Nth-level cache memory 332 are different from the address information in the memory write request, a cache miss occurs.

If the judging result of the step S374 indicates that the cache hit occurs, the cache device 370 executes the memory write request (Step S376). That is, the write data is updated in the corresponding cache line of the Nth-level cache memory 332 by the cache device 370. In addition, the stored data in the corresponding cache line is updated. Then, the memory write request is retired (step S388), indicating that the memory write request has been completed.

If the judging result of the step S374 indicates that the cache miss occurs, the memory write request is modified as a memory read request by the cache device 370 and the memory read request is transmitted from the cache device 370 to the system memory 360 (Step S382).

For example, in case that the cache miss occurs in the Nth-level cache memory 332, the memory write request is modified as a memory read request by the cache device 370 and the memory read request is transmitted from the cache device 370 to the system memory 360. Then, the system memory 360 generates a read data according to the memory read request, and the read data is transmitted back to the cache device 370. Since the memory read request corresponding to the read data is not issued by the central processing unit 350, the read data will not be transmitted back to the processing unit 350. In other words, the read data is transmitted to the cache device 370 only.

After the read data from the system memory 360 is received by the cache device 370, a write data in the memory write request is merged into the read data by the cache device 370 (Step S384). That is, the write date and the read data are merged as a merged data. Then, the address information and the merged data are stored into the cache line (step S386). Afterwards, the memory write request is retired (step S388).

As mentioned above, after the read data from the system memory 360 is received, the write data in the memory write request in the Nth-level command buffer 330 and the read data are merged as the merged data by the cache device 370. Then, the address information in the memory write request and the merged data are stored into a cache line of the Nth-level cache memory 332. After the memory write request in the Nth-level command buffer 330 is retired, the memory read request has been completed.

In the flowchart of FIG. 3C, the waiting time between the step S382 and step S384 is relatively long. In this embodiment, the Nth level of the cache device 370 comprises the Nth-level command buffer 330 and the write allocation buffer 331. The Nth-level command buffer 330 and the write allocation buffer 331 operate independently. In the waiting time, the cache device 370 can select the requests from the Nth-level command buffer 330 and execute the requests. As a consequence, the performance of the cache device 370 will not be deteriorated.

As mentioned above in FIG. 3B, when the memory write request is transmitted to the Nth level of the cache device 370, the memory write request is stored in the write allocation buffer 331. For example, in case that the Nth level of the cache device 370 continuously receives five memory write requests with the same address information, the five memory write requests are temporarily stored in the free entries of the write allocation buffer 331. Then, the five memory write requests will be sequentially executed by using the flowchart of FIG. 3C.

In order to further improve the performance, the method of temporarily storing the memory write request into the write allocation buffer as shown in FIG. 3B can be modified. Consequently, in case that plural memory write requests with the same address information are received, the write allocation buffer can use the least number of free entries to temporarily store the memory write requests.

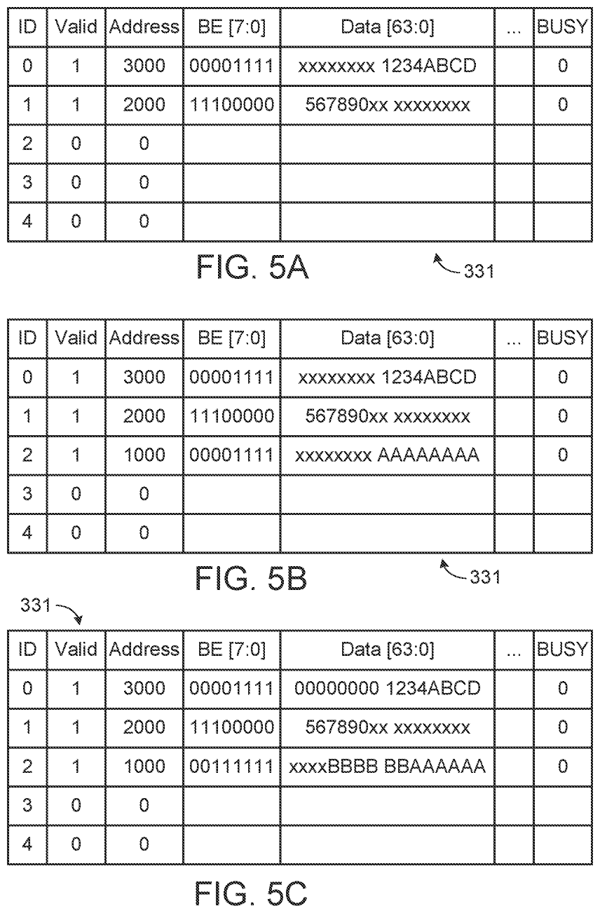

FIG. 4 is a flowchart illustrating a variant example of the method for managing the memory write request by using the write allocation buffer according to the second embodiment of the present invention. Firstly, a request is received by the Nth level of the cache device (Step S362). Then, the cache device 370 judges whether the request is a memory write request (Step S364). If the request is the memory write request, the memory write request is transmitted to the write allocation buffer 331 (Step S402). Whereas, if the request is another request, the request is temporarily stored in a free entry of the Nth-level command buffer (Step S366). Whenever a memory write request is transmitted to the write allocate buffer 331, the cache device 370 judges whether the address information recorded in any of the used entries of the write allocate buffer 331 is identical to the address information in the memory write request (Step S406). If the judging result of the step S406 indicates that all pieces of address information recorded in all used entries of the write allocate buffer 331 are different from the address information in the memory write request, the memory write request is temporarily stored in a free entry of the write allocate buffer 331 (Step S410).

If the judging result of the step S406 indicates that address information recorded in one used entry of the write allocate buffer 331 is identical to the address information in the memory write request, the cache device 370 judges whether plural pieces of address information recorded in plural used entries of the write allocate buffer 331 are identical to the address information in the memory write request (Step S408).

If the judging result of the step S408 indicates that plural pieces of address information recorded in plural used entries of the write allocate buffer 331 are identical to the address information in the memory write request, the write data in the memory write request is merged into the stored data in the newest used entry of the write allocate buffer 331 (Step S420). Then, the memory write request is retired (Step S422). In the step S420, one of the plural used entries with the same address information is determined as the newest used entry by the cache device 370, and the write data in the memory write request is merged into the stored data in the newest used entry.

If the judging result of the step S408 is not satisfied, it means that the address information recorded in a single used entry of the write allocate buffer 331 is identical to the address information in the memory write request. Then, the cache device 370 judges whether the write data in the memory write request can be merged into the corresponding used entry of the write allocate buffer 331 (Step S412).

If the judging result of the step S412 indicates that the write data can be merged into the corresponding used entry, the write data in the memory write request is merged into the stored data in the corresponding used entry of the write allocation buffer 331 (Step S416). Then, the memory write request is retired (Step S422).

If the judging result of the step S412 indicates that the write data cannot be merged into the corresponding used entry, the memory write request is temporarily stored into a free entry of the write allocation buffer 331 (Step S410).

As mentioned above, in case that the Nth level of the cache device 370 continuously receives plural memory write request with the same address information, the write data are properly merged into the stored data of the used entries of the write allocation buffer 331, and then the memory write request is retired. The cooperation of the managing methods of FIGS. 4 and 3C can effectively reduce the used number of the free entries of the write allocation buffer 331 and increase the performance of the cache device 370.

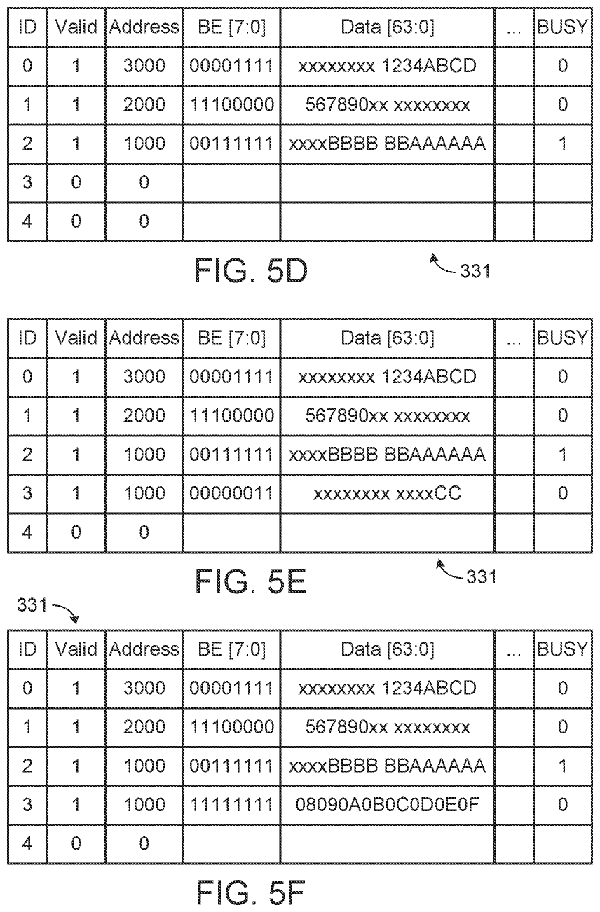

FIGS. 5A to 5F schematically illustrate some scenarios of the managing procedures in the write allocation buffer.

As shown in FIG. 5A, the write allocation buffer 331 comprises five entries. Each entry has an ID filed (ID), a valid field (Valid), an address information field (Address), a byte enable field (BE[7:0]), a data field (Data[63:0]) and a busy field (BUSY). In addition, each entry can be provided with additional fields with other functions according to the practical requirements. In FIG. 5A, only five entries are included in the write allocation buffer 331. It is noted that the number of the entries in the write allocation buffer 331 is not restricted. The entry with a smaller value in the ID filed (ID) represents that the memory write request has been temporarily stored in the write allocation buffer 331 for a longer time. In other words, the entry with the value “0” in the ID filed (ID) is the oldest entry, and the memory write request temporarily stored in the entry is the oldest memory write request.

The entry with the value “0” in the valid field (Valid) represents that the entry is a free entry. The entry with the value “1” in the valid field (Valid) represents that the entry is a used entry. As shown in FIG. 5A, the value in the valid field (Valid) of the entries with the values “0” and “1” in the ID filed (ID) is “1”. In other words, the entries with the values “0” and “1” in the ID filed (ID) is the used entries. The value in the valid field (Valid) of the entries with the values “2”, “3” and “4” in the ID filed (ID) is “0”, indicating that these entries are free entries.

In each entry, the value in the address information field (Address) is the address information, representing the address of the system memory to be updated by the memory write request.

In each entry, the byte enable field (BE[7:0]) and the data field (Data[63:0]) cooperate with each other. The value in the byte enable field (BE[7:0]) is a binary value, and the value in the data field (Data[63:0]) is a hexadecimal value. Moreover, the value “x” is a don't care value. For example, a cache line of the cache memory can record an 8-byte stored data (i.e., a 64-bit stored data). Consequently, the data length of the data filed (Data[63:0]) in each entry of the write allocation buffer 331 is 64 bits. Moreover, the value in the byte enable field (BE[7:0]) represents the location of the write data to be updated.

For example, the entry with the value “0” in the ID field (ID) is a used entry, and a first memory write request is temporarily stored in the used entry. The value in the byte enable field (BE[7:0]) is “00001111”, indicating that only the last four bytes of the eight bytes are updated in response to the first memory write request. That is, the write data contains four bytes “12”, “34”, “AB” and “CD” sequentially.

Similarly, the entry with the value “1” in the ID field (ID) is a used entry, and a second memory write request is temporarily stored in the used entry. The value in the byte enable field (BE[7:0]) is “11100000”, indicating that the first three bytes of the eight bytes are updated in response to the second memory write request. That is, the write data contains three bytes “56”, “78” and “90” sequentially.

In each entry, the value in the busy field (BUSY) indicates whether the used entry is being executed. For example, the value “0” in the busy field (BUSY) indicates that the memory write request in the used entry is not selected. Under this circumstance, the stored data in the corresponding used entry can be merged. In contrast, while the cache device 370 selects the first memory write request and judges whether the Nth-level cache memory 332 is hit by the first memory write request, the value in the busy field (BUSY) is set as “1”. Under this circumstance, the stored data in the corresponding used entry cannot be merged.

Please refer to FIG. 5A again. Then, the Nth level of the cache device 370 receives a third memory write request. The address information of the third memory write request is “1000”, the value in the byte enable field (BE[7:0]) is “00001111”, and the value in the data field (Data[63:0]) is “xxxxxxxxx AAAAAAAA”. Meanwhile, the cache device 370 judges that the address information field (Address) in each of the used entries of the write allocation buffer 331 does not record the address information “1000”. Since all pieces of address information recorded in all used entries are different from the address information “1000” in the third memory write request, the procedure as shown in FIG. 5B is performed. As shown in FIG. 5B, the third memory write request is temporarily stored into the free entry with the value “2” in the ID filed (ID) by the cache device 370. In other words, after the steps S362, S364, S402, S406 and S410 in the flowchart of FIG. 4 are performed, the third memory write request is temporarily stored into the free entry with the value “2” in the ID filed (ID).

Please refer to FIG. 5B again. Then, the Nth level of the cache device 370 receives a fourth memory write request. The address information of the third memory write request is “1000”, the value in the byte enable field (BE[7:0]) is “00111000”, and the value in the data field (Data[63:0]) is “xxxxBBBB BBxxxxxx”. Meanwhile, the cache device 370 judges that the address information field (Address) in one of the used entries of the write allocation buffer 331 records the address information “1000”. Since the address information recorded in the used entry with the value “2” in the ID filed (ID) is “1000” and the value in the busy field (BUSY) is “0”, the procedure as shown in FIG. 5C is performed. As shown in FIG. 5C, the write data in the fourth memory write request is merged into the stored data in the used entry with the value “2” in the ID field (ID) by the cache device 370. The value in the byte enable field (BE[7:0]) is modified as “00111111”, and the value in the data field (Data[63:0]) is merged as “xxxxBBBB BBAAAAAA”. Then, the fourth memory write request is retired. In other words, after the steps S362, S364, S402, S406, S408, S412 and S416 in the flowchart of FIG. 4 are performed, the write data in the fourth memory write request and the write data in the third memory write request are merged with each other. The fourth memory write request is not temporarily stored in the free entry. In addition, the fourth memory write request is retired.

Please refer to FIG. 5C again. Then, the cache device 370 selects the memory write request from the used entry with the value “2” in the ID field (ID) is “2”, and the cache device 370 judges whether the Nth-level cache memory 332 is hit by the memory write request. Consequently, as shown in FIG. 5D, the value in the busy field (BUSY) of the corresponding used entry is set as “1”.

Please refer to FIG. 5D. Then, the Nth level of the cache device 370 receives a fifth memory write request. The address information in the fifth memory write request is “1000”, the value in the byte enable field (BE[7:0]) is “00000011”, and the value in the data field (Data[63:0]) is “xxxxxxxx xxxxCCCC”. Meanwhile, the cache device 370 judges that the address information field (Address) in one of the used entries of the write allocation buffer 331 records the address information “1000”. However, since the address information field (Address) in the used entry with the value “2” in the ID field (ID) is “1000” and the busy field (BUSY) is “1”, the procedure as shown in FIG. 5E is performed. Consequently, as shown in FIG. 5E, the write data cannot be merged by the cache device 370. In addition, the fifth memory write request is temporarily stored into the free entry with the value “3” in the ID field (ID) of the write allocation buffer 331 by the cache device 370. In other words, after the steps S362, S364, S402, S406 and S410 in the flowchart of FIG. 4 are performed, the fifth memory write request is temporarily stored into the free entry with the value “3” in the ID field (ID). Meanwhile, two memory write requests with the same address information are temporarily stored into the write allocation buffer 331.

Please refer to FIG. 5E again. Then, the Nth level of the cache device 370 receives a sixth memory write request. The value in the address information field (Address) of the sixth memory write request is “1000”, the byte enable field (BE[7:0]) is “111111111”, and the data field (Data[63:0]) is “08090A0B0C0D0E0F”. Meanwhile, the cache device 370 judges that the address information field (Address) in at least one of the used entries of the write allocation buffer 331 records the address information “1000”. Since the address information field (Address) in the used entry with the value “2” in the ID field (ID) and the address information field (Address) in the used entry with the value “3” in the ID field (ID) are both “1000”, the procedure as shown in FIG. 5F is performed. As shown in FIG. 5F, the write data in the sixth memory write request is merged into the stored data in the newest used entry with the value “3” in the ID field (ID) by the cache device 307. As shown in FIG. 5F, the byte enable field (BE[7:0]) is modified as “11111111”, and the value in the data field (Data[63:0]) is merged as “08090A0B0C0D0E0F”. Then, the sixth memory write request is retired. In other words, after the steps S362, S364, S402, S406, S408, S420 and S422 in the flowchart of FIG. 4 are performed, the write data in the sixth memory write request and the write data in the fifth memory write request are merged with each other. The sixth memory write request is not temporarily stored into the free entry. In addition, the sixth memory write request is retired.

Furthermore, in the situation of FIG. 5D, the value in the busy field (BUSY) of the corresponding used entry is “1”. Meanwhile, the cache device 370 selects the memory write request in the used entry with the value “2” in the ID field (ID), and the cache device 370 judges whether the Nth-level cache memory 332 is hit by the memory write request. If the cache device 370 judges that the Nth-level cache memory 332 is not hit by the memory write request, the memory write request is modified as a memory read request, and the memory request is transmitted to the system memory 360. Meanwhile, a waiting time is required to wait for the system memory 360 to transmit back a read data. In the waiting time, the value in the busy field (BUSY) of the used entry with the value “2” in the ID field (ID) is modified as “0”. In case that the Nth level of the cache device 370 receives a seventh memory write request in the waiting time and the address information field (Address) in the seventh memory write request is “1000”, the write data in the seventh memory write request can be merged into the stored data of the used entry with the value “2” in the ID field (ID).

From above descriptions, the present invention provides method for managing a memory write request in a cache device of a computer system. The Nth level of the cache device 370 further comprises a write allocation buffer 331. The write allocation buffer 331 is only permitted to temporarily store the memory write request. Since the Nth-level command buffer 330 and the write allocation buffer 331 operate independently, the performance of the cache device 370 will not be deteriorated. Moreover, the present invention further provides a managing method for the write allocation buffer 331. In case that the Nth level of the cache device 370 continuously receives plural memory write request with the same address information, the write data are properly merged into the stored data of the used entries of the write allocation buffer. Consequently, the used number of the free entries of the write allocation buffer 331 can be effectively reduced.

In the above embodiments, the Nth level is the last level of the cache device 370, and the write allocation buffer 331 is included in the Nth level. It is noted that numerous modifications and alterations may be made while retaining the teachings of the invention. For example, in another embodiment, the write allocation buffer is not included in the last level. For example, the cache device 370 comprises P levels, wherein P is an integer larger than 2. The write allocation buffer is included in the N level, wherein N is an integer larger than 1 and smaller than P. Although the write allocation buffer is not included in the last level of the cache device, the purposes of the present invention can be also achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for managing a memory write request in a cache device, the cache device being coupled between a central processing unit and a system memory, the cache memory comprising plural levels, an Nth level of the cache device comprising an Nth-level command buffer, an Nth-level cache memory and a write allocation buffer, N being an integer larger than 1, the method comprising steps of:
receiving a request from a previous level;
if the request is the memory write request, temporarily storing the memory write request into a free entry of the write allocation buffer, wherein the memory write request contains an address information and a write data; and
if the request is not the memory write request, temporarily storing the request into a free entry of the Nth-level command buffer.

2. The method as claimed in claim 1, further comprising steps of:
(a) selecting the memory write request from the write allocation buffer, and judging whether the Nth-level cache memory is hit by the memory write request;
(b) if the Nth-level cache memory is hit by the memory write request, executing the memory write request, and then retiring the memory write request; and
(c) if the Nth-level cache memory is not hit by the memory write request, performing steps of:
(c1) modifying the memory write request as a memory read request, and transmitting the memory read request to the system memory;
(c2) allowing the write data and a read data from the system memory to be merged as a merged data;
(c3) storing the address information and the merged data into a cache line of the Nth-level cache memory; and
(c4) retiring the memory write request.

3. The method as claimed in claim 2, wherein if the Nth-level cache memory is hit by the memory write request, the address information in the memory write request is identical to an address information in a corresponding cache line of the Nth-level cache memory.

4. The method as claimed in claim 3, wherein when the memory write request is executed, the write data is updated in the corresponding cache line, so that a stored data in the corresponding cache line is updated.

5. The method as claimed in claim 2, further comprising a step of selecting and executing another request in the Nth-level command buffer in a waiting time between the step (c1) and the step (c2).

6. A method for managing a memory write request in a cache device, the cache device being coupled between a central processing unit and a system memory, the cache memory comprising plural levels, an Nth level of the cache device comprising an Nth-level command buffer, an Nth-level cache memory and a write allocation buffer, N being an integer larger than 1, the method comprising steps of:
(a) receiving a request from a previous level;
(b) if the request is not the memory write request, temporarily storing the request into a free entry of the Nth-level command buffer;
(c) if the request is the memory write request, transmitting the memory write request to the write allocation buffer, wherein the memory write request contains an address information and a write data;
(d) if all used entries in the write allocation buffer do not record a same address information as the address information in the memory write request, temporarily storing the memory write request into a free entry of the write allocation buffer;
(e) if only a specified used entry in the write allocation buffer records the same address information as the address information in the memory write request and the write data is mergeable, allowing the write data in the memory write request to be merged into a stored data in the specified used entry, and retiring the memory write request;
(f) if only the specified used entry in the write allocation buffer records the same address information as the address information in the memory write request and the write data is not mergeable, temporarily storing the memory write request into the free entry of the write allocation buffer; and
(g) if at least two used entries in the write allocation buffer record the same address information as the address information in the memory write request, allowing the write data in the memory write request to be merged into a stored data in a newest used entry, and retiring the memory write request.

7. The method as claimed in claim 6, further comprising steps of:
(h) selecting the memory write request from the write allocation buffer, and judging whether the Nth-level cache memory is hit by the memory write request;
(i) if the Nth-level cache memory is hit by the memory write request, executing the memory write request, and then retiring the memory write request; and
(j) if the Nth-level cache memory is not hit by the memory write request, performing steps of:
(j1) modifying the memory write request as a memory read request, and transmitting the memory read request to the system memory;
(j2) allowing the write data and a read data from the system memory to be merged as a merged data;
(j3) storing the address information and the merged data into a cache line of the Nth-level cache memory; and
(j4) retiring the memory write request.

8. The method as claimed in claim 7, wherein if the Nth-level cache memory is hit by the memory write request, the address information in the memory write request is identical to an address information in a corresponding cache line of the Nth-level cache memory.

9. The method as claimed in claim 8, wherein when the memory write request is executed, the write data is updated in the corresponding cache line, so that a stored data in the corresponding cache line is updated.

10. The method as claimed in claim 7, further comprising a step of selecting and executing another request in the Nth-level command buffer in a waiting time between the step (j1) and the step (j2).

11. The method as claimed in claim 6, wherein in the step (e), if a busy field corresponding to the specified used entry is not set, the write data is mergeable into the stored data in the specified used entry.

12. The method as claimed in claim 6, wherein in the step (f), if a busy field corresponding to the specified used entry is set, the write data is not mergeable into the stored data in the specified used entry.

13. The method as claimed in claim 6, wherein in the step (g), the at least two used entries in the write allocation buffer record the same address information as the address information in the memory write request, wherein among the at least two used entries, the used entry with a largest value in an ID filed is the newest used entry.
